(19) United States
(12) Patent Application Publication
(10) Pub. No.: US 2009/0065696 A1
(43) Pub. Date: Mar. 12, 2009

(54) DETECTION METHOD AND APPARATUS

(75) Inventors: Christopher Mark Mann, Cornwall (GB); Simon Ward Grave, Southampton (GB)

Correspondence Address: NIXON & VANDERHYE, PC, 901 NORTH GLEBE ROAD, 11TH FLOOR, ARLINGTON, VA, 22203, US

(73) Assignee: THRUVISION LIMITED, Oxfordshire (GB)

(21) Appl. No.: 12/279,803

(22) PCT Filed: Feb. 16, 2007
(86) PCT No.: PCT/GB07/00557

§ 371 Date: Oct. 20, 2008

(30) Foreign Application Priority Data
Feb. 16, 2006 (GB) 0603193.4

(51) Int. Cl. G01J 5/02

(52) U.S. Cl. 250/339.06; 250/339.02

(57) ABSTRACT

In a terahertz radiation detection system, an array of harmonic transmitters/receivers can be scanned across a field of view. By using an unbalanced pair of Schottky diodes in the mixer of a heterodyne receiver, the receiver can be converted to a transmitter, generating terahertz radiation at even harmonics of the local oscillator. By using local oscillators of different frequencies in the transmitter and a receiver, the receiver can detect the generated radiation. In alternative arrangements, the local oscillator of the transmitter might have the same frequency as that of the receiver but be modulated, either directly or simply as a result of the transmitter being scanned across the field of view. If modulated directly, it might be amplitude or frequency modulation, these having different advantages. A receiver can be switched between acting as a transmitter and as a receiver by turning on and off an electrical bias to the Schottky diode pair. Embodiments of the invention have the further advantages of high signal to noise ratio in the output and the use of narrow bandwidth processing of the IF output.

The present invention relates to a detection method and apparatus for use in detecting objects using the electromagnetic spectrum at wavelengths in the centimetre to sub-millimetre range and particularly, but not exclusively, to arrangements using a local oscillator for detecting a signal such as an image signal.

Embodiments of the invention are relevant from the microwave to the terahertz region of the electromagnetic spectrum. However, the terahertz region has particular benefit for many applications in offering high resolution in small systems and specific embodiments of the invention are described below which operate in the terahertz region. “Terahertz” in this context means the electromagnetic spectrum at wavelengths in the millimetre to sub-millimetre range.

Arrangements using a local oscillator include for example super heterodyne, heterodyne, homodyne or direct IF (“intermediate frequency”) detection and the use of direct amplification for detection where the amplifier is configured as a regenerative or self oscillating mixer. Embodiments of the invention are particularly suitable for use with superheterodyne and heterodyne harmonic mixers and even more so with balanced harmonic mixers such as subharmonic mixers.

(In heterodyne detection at wavelengths in the centimetre to sub-millimetre range, the local oscillator is frequency-shifted with respect to the incoming signal to be detected while in homodyne detection it has the same frequency.)

The range mentioned above is referred to herein generally as the terahertz spectrum. Terahertz radiation has been found a useful tool for imaging and other purposes because some materials are transparent to it which are opaque through the visible spectrum. This allows these materials to be “seen through” using terahertz radiation where they could not using visible optical radiation. For example, terahertz wavelengths have been used in imaging the earth's surface through the atmosphere and for improving visibility in bad weather (for example for flying or driving). Some materials can be distinguished under terahertz radiation because of their distinctive transmissivity or reflectivity and this has been used for example in detecting food or chemical components. Further, objects themselves can emit terahertz radiation, including the human body. This has been used for example in medicine for detecting skin cancer. Because clothing is generally transparent to terahertz radiation but weaponry is not, another application has been the detection of weaponry otherwise concealed about the person.

Cameras for imaging an object by use of the terahertz spectrum are known. For example, an arrangement is described in International Patent Application WO 2004038854 in the name Agence Spatiale Européenne. In this arrangement, the camera is based on a double bank of horn antennae which each pick up terahertz radiation, in use, which is mixed to extract an intermediate frequency signal using a local oscillator. This known heterodyne technique allows smaller detectors to be used at room temperature in the terahertz range than might otherwise be necessary and so supports finer resolution.

It is possible to use either active or passive terahertz imaging. In active imaging, a terahertz source can be used to illuminate an object or field of view. In passive imaging, there is no illuminating source, the terahertz detection regime just receiving terahertz radiation from an object or field of view. This might be for example because it has been reflected there and/or because the object or field of view itself is a source.

Passive imaging systems have an advantage in some applications, such as imaging humans, because there can be no inference that use of the system can cause physical harm. However, because the signal to noise ratio is relatively low with passive imaging, the speed with which an image can be built tends to be limited in comparison with active imaging systems. For some applications, it would thus be preferred to implement an active system. This can offer a much higher dynamic range allowing a greater variety of subjects to be examined but can demand high power levels, not necessarily available particularly in the terahertz region of the spectrum.

According to a first aspect of embodiments of the present invention, there is provided an electromagnetic radiation detection system, the system comprising a transmitter for transmitting radiation towards a target and a receiver for receiving radiation from the target, the received radiation having been transmitted by the transmitter, wherein the transmitter and receiver each have:
i) an input for a signal provided by a local source; and
ii) a mixer for generating a signal by use of the signal provided by the local source and comprising at least one frequency different from that of the local source,
   and wherein, in use, the received radiation is mixed by the receiver with a signal based on that provided by its local source to give a detection signal in relation to the target, the detection signal having an intermediate frequency characteristic.

The target will lie in a field of view in relation to the aperture of the receiver and the detection signal might be used for instance to detect an object in the field of view and/or to form an image of part or all of the field of view.

Embodiments of the invention can be arranged as an array of transmitters and receivers as described above, in which the transmitters and receivers have the same general construction but one or more is used to illuminate the field of view and one or more is used in forming an image signal in relation to the field of view.

In order for the mixer of the receiver to give an intermediate frequency for use in imaging, the received radiation needs to have a frequency characteristic carrying information from the field of view which is close to but different from a frequency characteristic present in its mixer. For example, the difference might be up to 40 GHz but preferably is considerably less. The frequency difference might arise for more than one reason. For example, the signal provided by the local source of the transmitter that generated the received radiation might have a frequency characteristic which is different from the signal provided by the local source of the receiver. Alternatively, the two local sources might be the same but the radiation received from the field of view will contain a very low frequency signal component that changes and is thus detectable. For example, the change may come about from movement of an object in the field of view that would cause Doppler shift, or as a result of scanning the field of view so as to cause a change in amplitude. In a third type of arrangement, one of the local sources might be modulated.

A convenient form of receiver which can be used in embodiments of the present invention is the sub-harmonic receiver. In a sub-harmonic receiver, received radiation is mixed with a signal generated by the receiver's local source to produce a frequency response comprising one or more harmonics of the signal from the local source, plus sidebands to the one or more harmonics. These sidebands provide the intermediate frequency (“IF”) characteristic which can be downconverted, filtered, amplified and used in detection or imaging.

This form of receiver can also be used as the transmitter in embodiments of the present invention. This depends on the frequency responses of the mixers in the transmitter and the receiver. In known sub-harmonic receivers, the frequency response tends to show not only sidebands (that is, mixing) but also signal generation at harmonics of the signal from the local source. To simplify IF signal extraction in this known arrangement, signal generation is suppressed at the even harmonics leaving just the sidebands due to mixing at the even harmonics. Considerable work has been done to achieve this signal generation suppression, for example using balanced diodes as the mixer. The sidebands at the even harmonics can then be easily downconverted and filtered to give an IF output.

However, in embodiments of the present invention, it has been realised that it is possible and advantageous to use a previously unwanted characteristic of the frequency response of a radiation detector not to detect but to illuminate a field of view. Another detector can be used as a receiver. It is then possible to improve the detecting process significantly. In embodiments of the present invention, signal generation at an even harmonic, in a transmitter having the same overall structure as a sub-harmonic receiver, is retained and used to illuminate the field of view. Once the radiation has been imprinted with information by the field of view, as long as it can be mixed to produce sidebands at the receiver, it can be detected as an IF signal and filtered out appropriately for use in detecting a target or imaging the field of view. Thus a previously unwanted frequency characteristic is used in the “other direction”, being emitted towards the field of view and detected by a different receiver. The emitting “detector” is thus being used instead as a “harmonic transmitter”.

In an embodiment of the invention in its first aspect, it is convenient to use a harmonic transmitter as described above, together with a harmonic receiver. Using a pair of diodes in each, in a manner known for use in harmonic receivers, it becomes possible to switch one or both of the transmitter and the receiver between behaviours appropriate for transmitting and for receiving. This is possible because the balance between a pair of diodes can be controlled, for instance by applying an electrical bias, either voltage or current, to the pair. The electrical bias can then be used to implement a controller for controlling signal generation at the even harmonics and thus whether the transmitter/receiver is adapted for use in illuminating the field of view or in detecting radiation incoming from the field of view.

Thus in embodiments of the invention in its first aspect, either or both of the transmitter and receiver may further comprise a controller for controlling signal generation, for example at one or more even harmonics of the signal provided by the local source. In particular, the mixer of the transmitter or the receiver may comprise a pair of diodes and the controller may comprise a balance control in relation to the pair of diodes, such as a controllable electrical bias. Such an arrangement offers electrical control which can be applied in different ways. For example, it offers simple manual on/off control or could be controlled electronically, for instance according to a predetermined regime or in response to conditions in real time.

In an imaging system comprising one or more transmitters with a controller for controlling signal generation, the system can be used in an active mode in which radiation is emitted towards the field of view by the transmitter(s), or in a passive mode in which radiation is only received from the field of view. Optionally, the transmitter(s) can be used as detectors when the system is in passive mode. Thus the controller enables mode control for switching between active and passive behaviour.

In practice, each transmitter can act as a receiver at the same time as transmitting.

In known systems that use active illumination, in general the whole field of view is flood illuminated. This can require a large amount of power which is not usually available in the terahertz domain. In embodiments of the present invention, using an array of transmitters/receivers, the paths of radiation emitted towards the field of view and received back from it are substantially parallel and each receiver will generally only receive radiation that has been generated by one or a small number of transmitters. Only that part of the field of view which is detectable by any one or more receivers at any one moment need be illuminated. Thus the transmit power can be significantly reduced.

By using transmitter/receivers which operate using superheterodyne, heterodyne, homodyne, zero IF or a form of self oscillating mixing, a dynamic range and signal to noise ratio (“SNR”) can be achieved which is of the order of 100 dB. This allows the use of extremely low transmit powers. For example, the transmit power can potentially be brought lower than the naturally occurring background electromagnetic radiation. Although this is still referred to herein using terms such as “active illumination” or an “active mode” or the like, it should be borne in mind that an “active” system can in practice have a lower transmit power than the power present in a supposedly “passive” system such as a body at room temperature. The term “active” only means there is an output towards a field of view which is generated in a transmitter or transmitters, which therefore will generally have known characteristics and which can be detected. The active illumination generated in a transmitter or transmitters in embodiments of the invention may for example provide a narrow band signal, or a set of narrow band signals, distinguishable from background radiation. Indeed, transmitters for use in this technical field and in embodiments of the present invention as described below are capable of generating a narrowband signal that comprises a single discrete sine wave.

According to a second aspect of embodiments of the present invention, there is provided a transmitter/receiver for use in a system as described above, comprising:
i) an input for a signal provided by a local source;
ii) a mixer comprising a pair of anti-parallel diodes for generating a signal based at least in part on the signal provided by the local source;
iii) an electrical bias input for providing an electrical bias to at least one of the diodes so as to control the balance between the diodes; and
iv) an electrical bias control for controlling the level of the electrical bias so as to control said balance and thus the frequency content of the generated signal.

Each electrical bias control can be arranged to switch the diodes between balanced and unbalanced states in which the transmitter/receiver respectively suppresses or generates even harmonics of the signal provided by the local source and is thus operating in a receiving or transmitting mode. The electrical bias control can thus provide a mode control for switching between active and passive modes.

An embodiment of the present invention might comprise a transmitter with simultaneous receiving capability based on a sub-harmonic heterodyne mixer incorporating anti-parallel Schottky diodes. Sub-harmonic mixers are provided with a local source whose frequency is multiplied up to a higher harmonic, for instance doubled, in the mixing process. Consequently, the drive for the local source can be at half (or other appropriate fraction of) the frequency the receiver is intended to detect. Sub-harmonic mixers incorporating anti-parallel Schottky diodes provide an excellent way of providing simultaneous detection and transmission in an electronically controlled system.

Suitable diodes for use in embodiments of the present invention are described in the following publication:

“Glass Reinforced GaAs Beam Lead Schottky Diode with Airbridge for Millimetre Wavelengths”, published in Electronics Letters, 13 Sep. 1984, Vol. 20 No. 19 Page 787.

In an alternative arrangement, it would also be possible to use super heterodyne sub-harmonic mixers incorporating anti-parallel Schottky diodes as the active element of the receiver/transmitter. However, these require somewhat specialised low noise amplifiers.

According to a third aspect of embodiments of the present invention, there is provided a scanning electromagnetic radiation detection system comprising:

i) at least one transmitter for transmitting radiation towards a target;
ii) at least one receiver for receiving radiation from the target, said radiation having been transmitted by the transmitter; and
iii) a scanner for scanning the target,
wherein the scanner is arranged to scan the at least one transmitter and the at least one receiver synchronously with respect to the target.

For example, the at least one transmitter and the at least one receiver may be present in an array of transmitters and receivers and the scanner may for example move the array to scan the target or may control an optical path defining element, such as a mirror, to scan the target with respect to the array. Scanning arrangements are known which would be suitable for use. An example is that described in co-pending British patent application GB0511209.9 in the name ThruVision Limited.

By subjecting the at least one transmitter to a scanning mechanism in synchronism with the at least one receiver, the power levels necessary to illuminate the field of view are much reduced compared with known arrangements using flood illumination of the whole field of view.

Preferably, the scanning electromagnetic radiation detection system further comprises a modulator for modulating the radiation transmitted by the transmitter in a manner detectable at the receiver. Modulation can be used in various ways to enhance the use of the detection system. For example, modulation may make it possible to track a moving target, including measuring its speed.

Where the at least one transmitter and the at least one receiver are based on the use of a mixer to mix a frequency of a local source with received radiation to create a frequency response, modulation of the illuminating radiation produced by the transmitter can be used to produce one or more relatively precisely predictable frequencies in the frequency response of the receiver which in turn means a significantly reduced bandwidth can be applied in the receiver, leading to a significantly improved signal to noise ratio in the receiver.

According to a fourth aspect of embodiments of the present invention, there is provided an electromagnetic radiation detection system comprising an array of:

i) at least one transmitter for transmitting radiation towards a target; and
ii) at least one receiver for receiving radiation from the target, said radiation having been transmitted by the transmitter;
wherein said transmitted radiation has more than one discrete frequency.

For example, if the transmitter is a sub-harmonic transmitter then the transmitted radiation might be generated from more than one different harmonic of the frequency of the local source.

Such a system may comprise more than one transmitter, wherein different discrete frequencies are transmitted by different respective transmitters.

The receiver may be adapted to receive said more than one discrete frequency. An example of such a receiver is a subharmonic receiver adapted to receive radiation having frequencies close to harmonics of its local source. That is, the frequency of its local source is selected such that the harmonics generated in the receiver will produce one or more intermediate frequencies when mixed with the received radiation. Alternatively, there may be provided more than one receiver, these being adapted between them to receive the more than one discrete frequency.

Embodiments of the present invention in its fourth aspect support illumination of at least part of the field of view with radiation of more than one frequency. This enhances the potential performance of the imaging system in detecting objects or materials in the field of view which only reflect radiation over one or more relatively limited portions of the radiation frequency spectrum.

Further inventive features of embodiments of the invention are as set out in the claims hereto.

It is to be understood that any feature described in relation to any one embodiment may be used alone, or in combination with other features described, and may also be used in combination with one or more features of any other of the embodiments, or any combination of any other of the embodiments.

A heterodyne THz transmitter/receiver will now be described as an embodiment of the present invention, by way of example only, with reference to the accompanying figures in which:

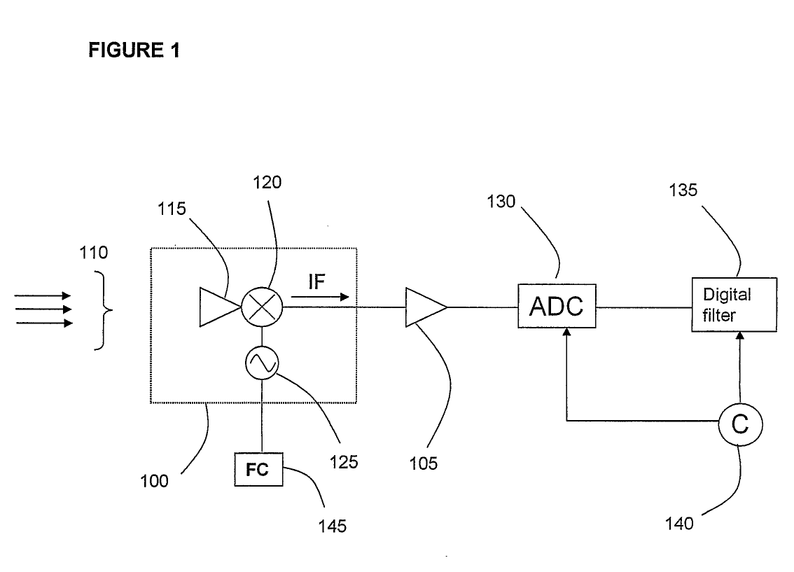

FIG. 1 shows a block diagram of the transmitter/receiver;

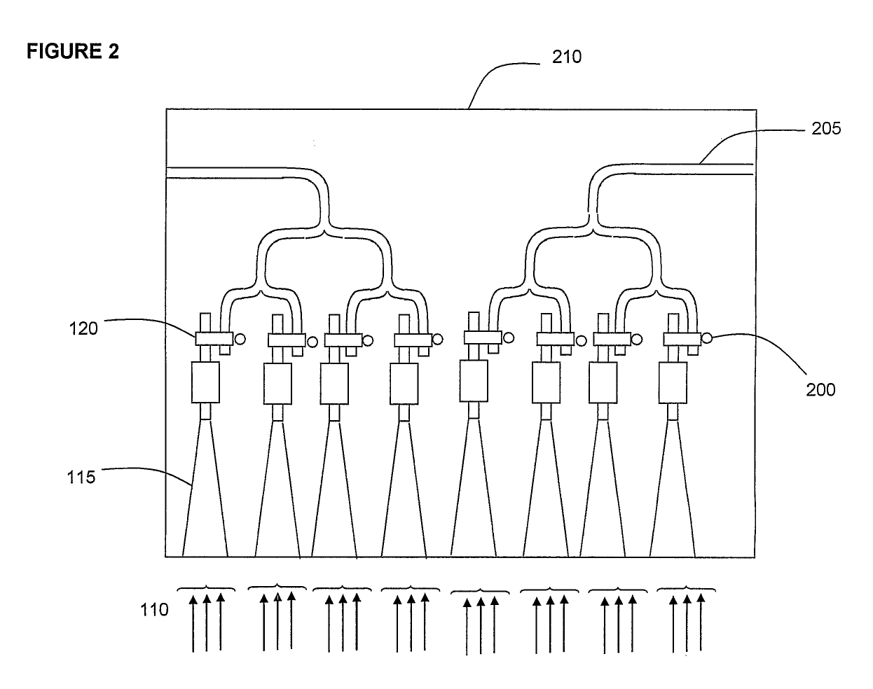

FIG. 2 shows in plan view part of a structure providing a set of mixers of the transmitter/receiver together with their local oscillator feed and IF output;

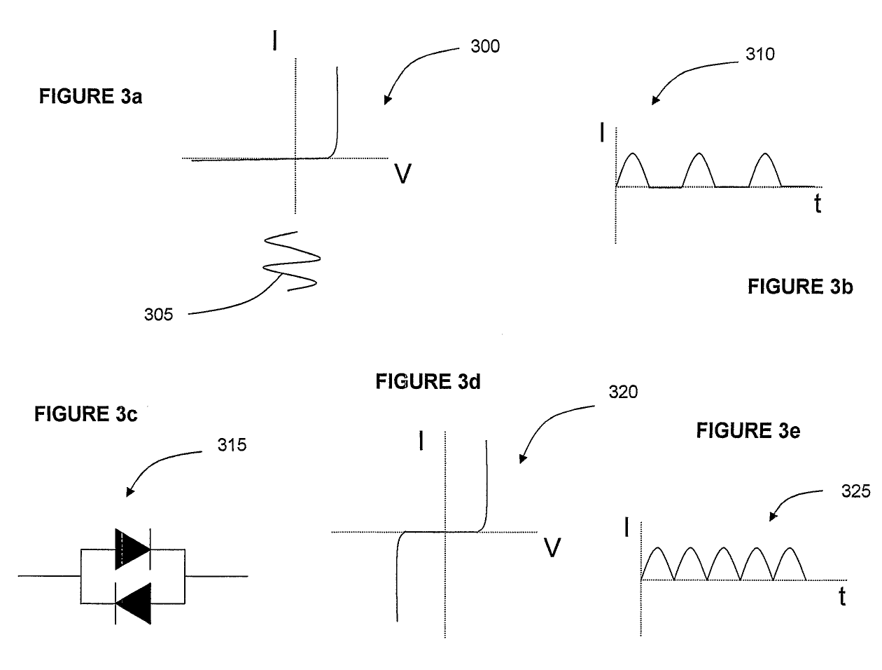

FIGS. 3a and 3b show the current/voltage and conductance characteristics of one Schottky diode and FIGS. 3c to 3e show a balanced anti-parallel pair of Schottky diodes and the current/voltage and conductance characteristics of the pair, these underlying the performance of sub-harmonic mixers for use in the transmitter/receiver of FIG. 1;

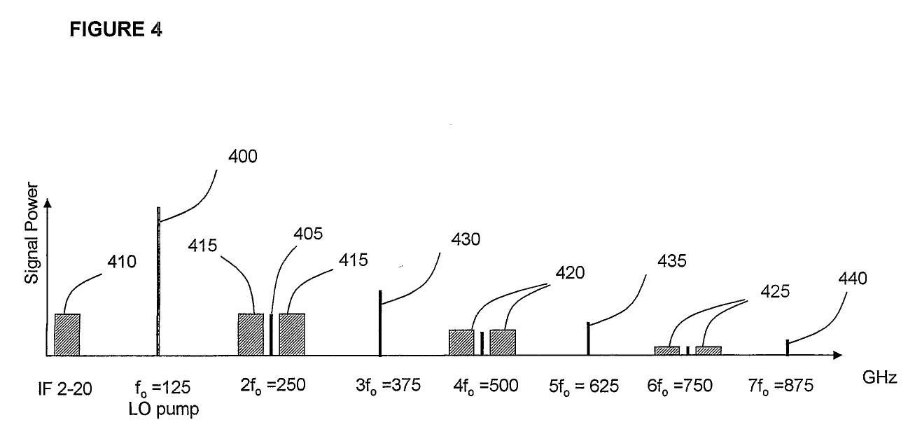

FIG. 4 shows both detected and transmitted frequencies in the overall frequency response of a mixer using the balanced Schottky diode pair of FIG. 3;

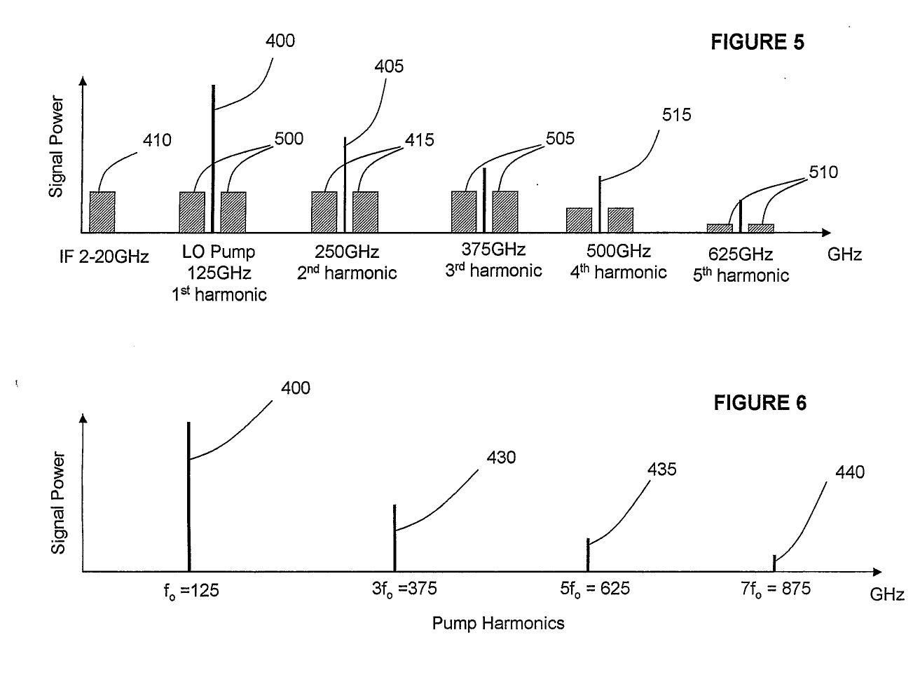

FIG. 5 shows both detected and transmitted frequencies in the overall frequency response of a mixer using an unbalanced Schottky diode pair;

FIG. 6 shows just the generated frequencies of a mixer using the balanced Schottky diode pair of FIG. 3;

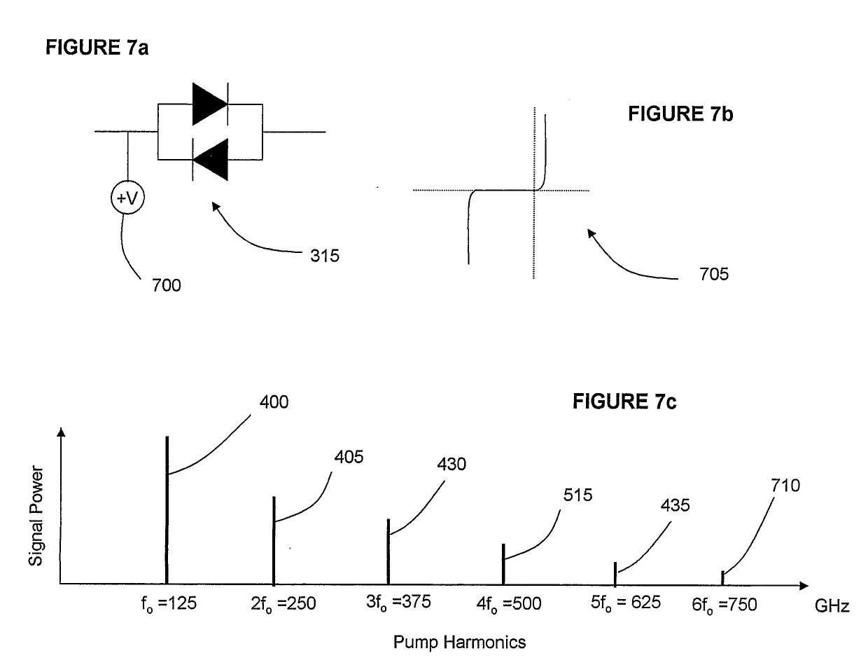

FIGS. 7a to 7c show a preferred arrangement of Schottky diodes for use in the transmitter/receiver of FIG. 1, together with its current/voltage characteristics and the generated frequencies of a mixer using the preferred arrangement;

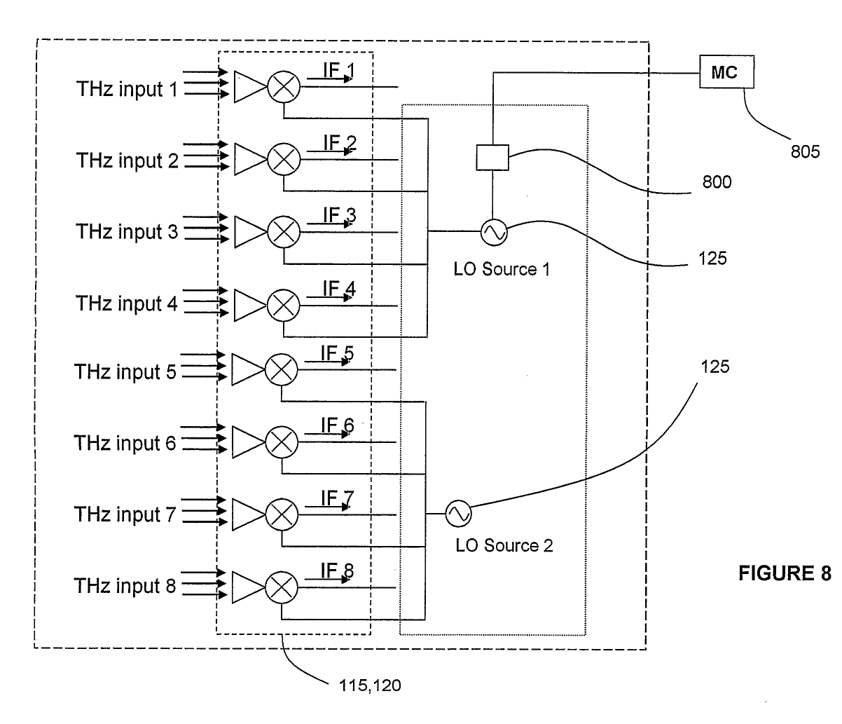

FIG. 8 shows a schematic diagram of a double array of transmitter/receivers such as that shown in FIG. 1, the transmitters/receivers of each array sharing a local oscillator;

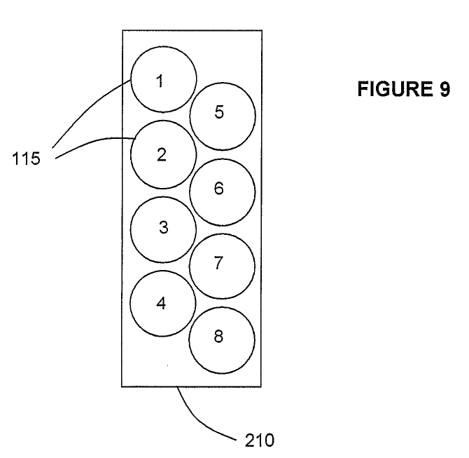

FIG. 9 shows schematically the physical arrangement of horn apertures of eight transmitter/receivers in a double array as shown in FIG. 8;

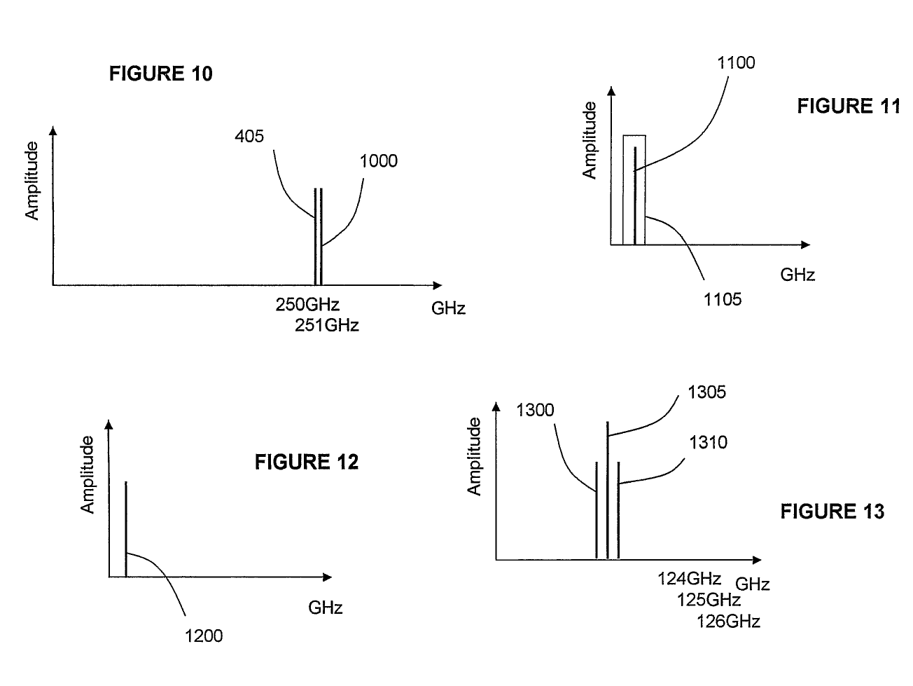

FIG. 10 shows frequencies present in the mixer of a receiver as shown in FIG. 1 in use;

FIG. 11 shows a band pass filtered IF signal obtained by mixing the frequencies shown in FIG. 10;

FIG. 12 shows a 1 GHz signal for amplitude-modulating a local oscillator in an alternative arrangement for obtaining an IF signal for use in detection;

FIG. 13 shows the sidetones obtained in the local oscillator output in the arrangement of FIG. 12;

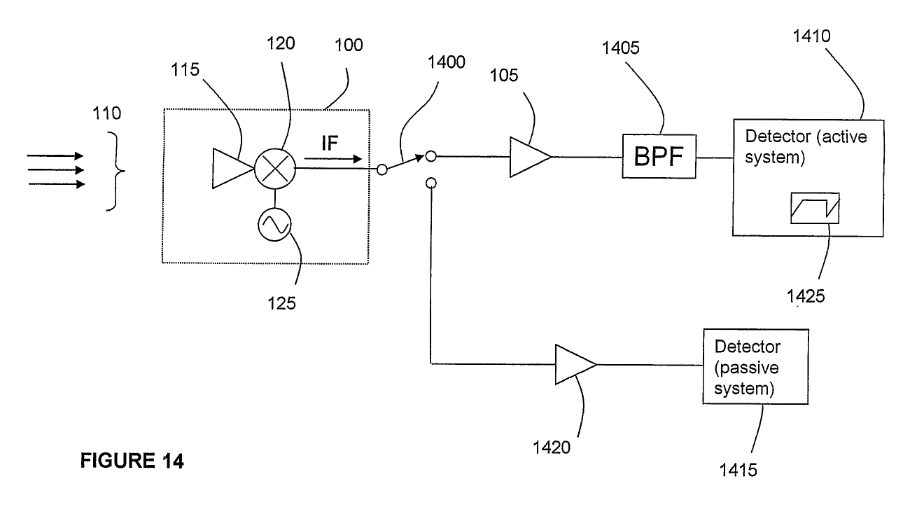

FIG. 14 shows a switched arrangement for switching between a high bandwidth output and a low bandwidth output from a mixer operating in passive and active modes respectively;

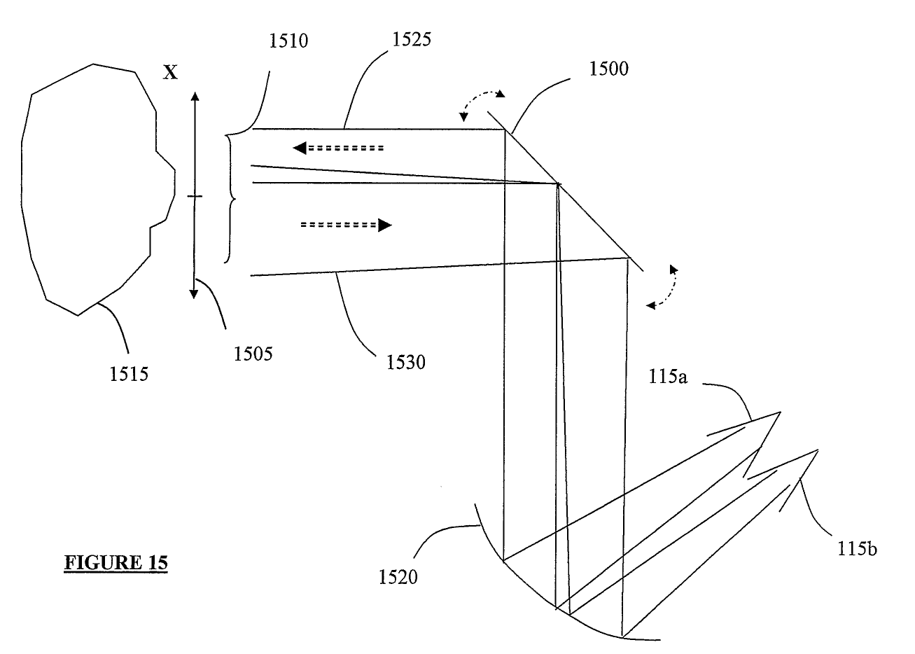

FIG. 15 shows part of an arrangement for scanning a field of view using an array of transmitter/receivers as shown in FIG. 8;

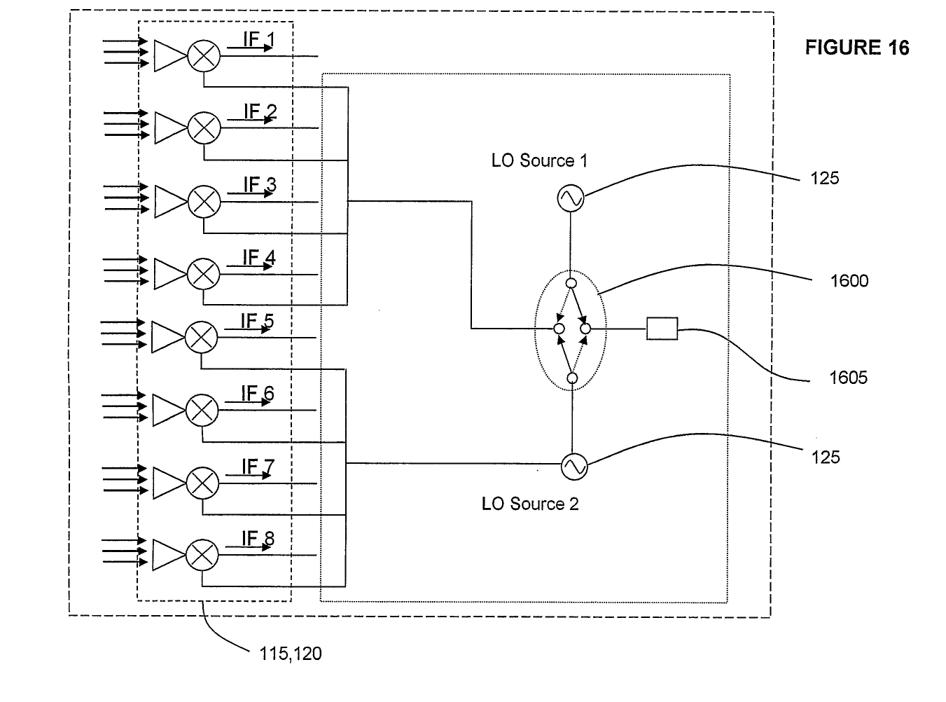

FIG. 16 shows the double array of FIG. 8 with a switchable arrangement of local oscillators at different frequencies to at least one of the arrays; and

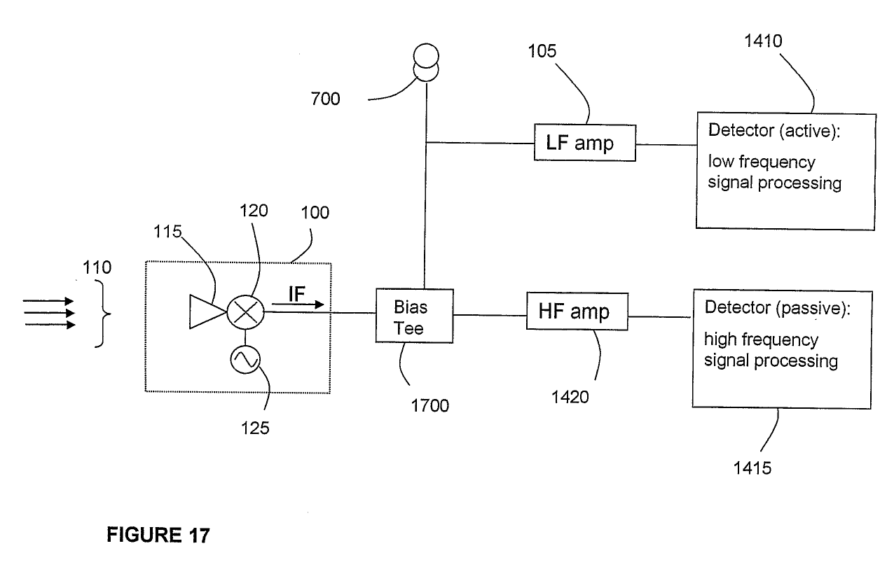

FIG. 17 shows an arrangement in which a mixer can be used in active and passive modes simultaneously.

It might be noted that the figures are schematic only and none of them is drawn to scale.

Referring to FIG. 1, the transmitter/receiver comprises a mixer portion 100 followed by an amplifier 105 for the IF output of the mixer portion 100. The amplifier 105 is followed by an analogue to digital converter (ADC) 130 and then a digital filter 135. The ADC 130 and the digital filter 135 are synchronised by a clock 140. Terahertz radiation 110 incoming from a field of view to the mixer portion 100 is fed into a diode-based mixer 120, or other mixer possessing a degree of bi-directivity, via a feedhorn 115 and combined with a reference signal, here provided by a local oscillator (LO) 125.

The mixer 120 incorporates a nonlinear element such as a Schottky diode and this combines the received terahertz radiation 110 with the reference signal to produce sum and difference signals, including an intermediate frequency (IF). The IF is normally low in frequency relative to the terahertz radiation 110 and reference signal, typically 0.1-40 GHz for the IF versus 200-10000 GHz for the terahertz radiation 110 and reference signal. Because the IF is now low frequency it can be readily amplified, and rectified if necessary, to produce a voltage that is directly proportional in strength to that of the received terahertz radiation 110 and can subsequently be used to form an image in relation to the field of view.

Rectification arises because it is necessary to detect the power that is received and rectification is one way this can be done. An alternative is to sample the signal in an analogue to digital converter (“ADC”).

### Feedhorn Array

Referring to FIG. 2, the feedhorn 115 and mixer 120 can in practice be built as part of an array of feedhorns, each with its mixer. One local oscillator (not shown in FIG. 2) can supply a reference signal along a branched path 205 to several of the mixers 120.

The design of feedhorns and other parts of the mixer to receive various frequencies of radiation is fairly well-established and thus not further discussed herein. However, it might be noted that in any arrangement in which incoming radiation might have a wide range of frequency, it may be necessary to adapt the feedhorn 115 and other parts of the mixer to allow radiation across a sufficient range of frequencies to pass.

The general construction of the array shown in FIG. 2 can be fabricated by epitaxial methods as described in International Patent Application WO 2004038854 in the name Agence Spatiale Européenne. That is, a three layer structure is made, the middle layer being etched on both faces and upper and lower layers being etched in a complementary fashion on just one face. When the upper and lower layers are brought into registration with the middle layer, a double array of feedhorns 115, locations for the mixers 120 and input channels 205 for reference signals is created.

The upper and lower layers additionally carry metallised holes to contact the IF outputs 200 from the mixers 120 and to supply bias signals to the diodes in the mixers 120 (not shown).

FIG. 2 shows only a plan view of the middle layer of such a construction.

### Mixing and Signal Generation

Referring to FIG. 3, each mixer 120 in practice comprises a non-linear mixing element such as a pair of Schottky diodes, in anti-parallel configuration. Referring to FIG. 3a, a conventional Schottky diode has a known current/voltage response 300 to a local oscillator (“LO”) drive signal 305. Referring to FIG. 3b, looking at conductance over time 310, mixing using a single Schottky diode occurs at a frequency corresponding to that of the local oscillator drive signal 305. Referring to FIGS. 3c to 3e, when two Schottky diodes are connected in an anti-parallel configuration 315, the current/voltage response 320 to the local oscillator drive signal 305 is anti-symmetric and the conductance over time 325 now produces mixing at a frequency which is double that of the local oscillator drive signal 305. This means that the local oscillator drive signal 305 need only be of the order of half the frequency of the radiation it is intended to detect.

Mixers of the general type shown in FIG. 3c, in which the local oscillator drive signal 305 can be used to detect a frequency which is a higher harmonic, are generally referred to as sub-harmonic mixers. Suitable mixers are known and an example of a type of mixer that might be used is disclosed in a paper by B P Moyna, C M Mann, B N Ellison, M L Oldfield, D N Matheson, and T W Crowe, entitled “Broadband Space-Qualified Subharmonic Mixers at 183 GHz with Low Local Oscillator Power Requirement”, published in the Proceedings of the 2nd ESA Workshop on Millimetre Wave Technology and Applications, Espoo, 27-29 May 1998.

In mixers of this general type, it can be necessary to prevent unwanted higher harmonics of the LO 125 being emitted from a receiver. Filters for doing this job are known and include for example a band pass filter such as a waffle filter which can be used in the RF input circuit. This topic is discussed in “Microwave Filters, Impedance Matching Networks, and Coupling Structures”, by C. G. Matthaei, L. Young, and E. M. T. Jones, published in New York, 1964, by McGraw-Hill. At terahertz frequencies, it will be understood that care must be taken to ensure that such a filter does not introduce unnecessary attenuation of a desired frequency.

Referring to FIG. 4, the operation of a conventional anti-symmetric sub-harmonic mixer can be examined from a mathematical perspective and when this is done it is found that mixing is centred about even multiples of the LO frequency “f₀”. FIG. 4 displays the overall frequency response of a 250 GHz balanced sub-harmonic mixer of the type shown in FIG. 3c, in use, having an anti-symmetric current/voltage response 320 and being driven by a 125 GHz LO.

In the mixer, the LO input signal 400 is doubled in frequency, providing the second harmonic 405 which mixes with received radiation to create sidebands 415. FIG. 4 also shows these sidebands downconverted to create an IF signal 410. In practice, higher harmonics are also present and create additional sidebands 420, 425 which also contribute to the IF signal 410.

In this balanced diode arrangement, it can be seen that both mixing and signal generation occur at the harmonics with mixing occurring primarily around the even harmonics and generation occurring primarily at the odd harmonics. Thus sidebands 415, 420, 425 appear about the even harmonics 2f₀, 4f₀, 6f₀ and signals 430, 435, 440 are generated at the odd harmonics 3f₀, 5f₀, 7f₀, although at increasingly low power levels as the order of the harmonic goes up. As long as the diodes are balanced, signal generation at the even harmonics, such as the second harmonic 405, is significantly suppressed.

In practice, it is the down-converted IF component 410 which is desired in detecting THz radiation because this is at a low enough frequency to amplify relatively simply to produce a useful detection signal. Thus a filter can be used to block all higher frequencies from the IF output of the mixer 120.

However, in embodiments of the present invention, it is the intention that a first mixer 120 should be used at least some of the time in transmitting THz radiation towards the field of view which can then be detected by a second mixer 120. It now becomes desirable to use at least one generated harmonic in the overall frequency response, in the transmit direction towards the field of view, which generated harmonic can be used to produce an IF component for downconversion at the second mixer 120.

Referring to FIGS. 5, 6 and 7, in the following description based on use of a detector 100 as shown in FIG. 1, it is shown that it is possible to suppress or enhance even order or odd order harmonics in the frequency response of a mixer 120, depending on the requirements. It becomes possible in embodiments of the invention to convert what is essentially a passive THz detection system as described in International Patent Application WO 2004038854 into an active system which illuminates as well as detecting. As will also be described below, it is also possible to create an imaging system with a very high signal to noise ratio (“SNR”).

To be more specific, in the context of embodiments of the present invention, a “passive” system just detects illumination from a field of view whereas an “active” system both illuminates and detects that illumination.

FIG. 5, in contrast to FIG. 4, shows the overall frequency response of a sub-harmonic mixer having an asymmetric (for example, unbalanced or biased) non-linear mixing element. In practice, this is often the situation since it is physically difficult to fabricate exactly balanced diodes for use in an anti-parallel pair.

As shown in FIG. 5, both mixing and signal generation now occur at every harmonic.

Looking just at signal generation, FIG. 6 shows the generated frequencies in the balanced arrangement of FIG. 3c. As in FIG. 4, it can be seen that only the odd harmonics 430, 435, 440 of the single tone drive frequency 400 (125 GHz) are generated when the diodes of an anti-parallel pair 315 are balanced. This is a suitable arrangement for detecting THz radiation since there will be less noise in the system overall, half the harmonics being suppressed. There will in practice be some signal generation at even multiples of the drive frequency but this will be orders of magnitude lower than signal generation at the odd multiples of the drive frequency if the diodes are suitably balanced.

Referring to FIG. 7c, this shows the generated frequencies in the unbalanced arrangement relevant to FIG. 5. Here, it can be seen that now both the odd and even harmonics 405, 430, 515, 435, 710 of the single tone drive frequency 400 (125 GHz) are generated when the diodes of an anti-parallel pair 315 are unbalanced. This is a suitable arrangement for transmitting radiation back towards the field of view for detection by a second mixer 120.

### Switched Active/Passive

It would be possible to use the first mixer always to transmit radiation and the second mixer always to detect radiation. However, in embodiments of the present invention, the same transmitter/receiver can be used as either a transmitter or a receiver, it being possible to switch one mixer between different overall frequency responses, a first one appropriate to receiving THz radiation and outputting an IF signal and a second one appropriate to sending THz radiation back towards the field of view as illumination for another transmitter/receiver to detect. Referring to FIG. 7a, a simple method for achieving a switchable transmitter/receiver of this type is to provide an input for an electrical bias 700 to be applied to one of the diodes of an anti-parallel pair 315 being used as mixing elements. When the electrical bias 700 is applied, the current/voltage response 705 of the pair 315 is shifted, as shown in FIG. 7b, so that it is no longer anti-symmetric and the overall frequency response of the mixer to a single tone pump signal changes.

The electrical bias 700 referred to could be provided as either a bias current or a bias voltage.

A switchable arrangement using an electrical bias 700 provides a mode control in that one mixer 120 can be switched, by switching the bias on and off, between different overall frequency responses, one more suitable for generating THz radiation and one more suitable for detecting THz radiation. This form of switching is an intrinsically fast process limited purely by the speed of the bias circuit. FIGS. 6 and 7c thus show generated frequencies in the frequency response of a sub-harmonic mixer 120 using the mixing elements of the FIG. 7a configuration. In the case of FIG. 6 there is no bias 700 and in the case of FIG. 7b the bias 700 has been switched on.

The provision of the electrical bias 700 can have a secondary advantage. In conventional detecting arrangements, in order to avoid radiation being emitted back towards the field of view at inappropriate frequencies, particularly for instance the very strong LO pump signal 400, and to reduce noise in the IF output, filtering would be used to suppress unwanted components of the frequency response. This can complicate the circuit design considerably. It is possible instead to use the same electrical bias 700 but now at a different level to “fine tune” the balance between the bidirectional elements of the sub-harmonic mixer 120 when it's intended for use in receiver mode. This can significantly reduce or eradicate the requirement for a filter construction to suppress unwanted frequency components of the mixer performance when operating in receiver mode. For example, if a bias current 700 of the order of 1 mA is used to unbalance the diodes and switch a mixer 120 into transmitting mode, then a bias current 700 which is a fraction of Iₛ, the diode saturation current, for instance of the order of just 0.1 mA, might be found enough to balance any intrinsic imbalance between the two diodes and thus switch the mixer 120 into receiving mode.

The use of an electrical bias 700 can be replaced or supplemented in at least some receivers of an array by other RF filter constructions, such as physical dimensions within the receivers, but these are likely to be considerably less flexible and/or accurate than the use of the electrical bias 700.

### Active/Passive Arrays

In general, a terahertz detector 100 as shown in FIG. 1 and utilising a sub-harmonic heterodyne mixer as described above can be readily incorporated into an array, thus speeding up image acquisition time. Such an array can incorporate first and second mixers with slightly different frequency pump signals 400 as described above and thus be capable of acting as an active array.

A number of such detectors 100 can be driven by a common pump signal as long as they all require the same frequency, in an arrangement such as that shown in FIG. 2. There is however a limit imposed on the number of detectors 100 that can be driven by a single LO source 125 as each mixer 120 requires a threshold power of 0.1-10 mW depending on configuration. Terahertz LO sources 125 have limited power output at 1-200 mW. Consequently for large arrays more than one LO source 125 would be required even where the frequency is shared. If the array incorporates first and second mixers 120 with slightly different frequency pump signals 400 then at least two LO sources 125 will generally be required to provide the different frequencies, as shown schematically in FIG. 8.

Referring to FIG. 8, typically one LO source 125 can supply four mixers 120. For example, a Gunn diode oscillator could be used as the LO source 125 for four mixers 120 based on anti-parallel Schottky diodes. So an array of eight sub-harmonic mixers 120 would typically consist of two arrays of four mixers, each array of four pumped by a single Gunn Diode oscillator LO source. This is shown in FIG. 8 where there is an “LO Source 1” and an “LO Source 2”.

Referring to FIG. 9, in practice the two arrays of four mixers 120 would be positioned so that the apertures of their horns 115 are next to one another to facilitate close packing requirements for optimum optical resolution.

### Switched Passive/Active Array: Fixed LO Frequencies, Switched by Electrical Bias

In an arrangement as shown in FIGS. 8 and 9, each array of four mixers 120 is driven by its own independent LO source 125. LO source 1 is set to a frequency of 125.0 GHz and LO source 2 is set to a frequency of 125.5 GHz.

In a passive operating mode, both arrays of four mixers 120 are balanced and no electrical bias (or just a small bias to achieve improved balance) is applied to the Schottky diode pairs. In this mode, the mixers of each array will show a frequency response of the type shown in FIG. 4. They will be predominantly mixing at IF frequencies 415 centred around the second harmonic 405 of the LO sources 125. The second harmonics of the two arrays will lie at 250 GHz and 251 GHz respectively. They will on the other hand be producing power at the third harmonics 430 of their respective LO sources 125, that is at 375 GHz and 376.5 GHz respectively. Thus neither array is producing power at a frequency which the other array would mix. The difference in frequency between the second and third order harmonics 405, 430 (≈125 GHz) is much greater than the typical upper IF frequency (20-40 GHz) and there is no down conversion. Hence the detected THz signal seen in each set of mixers is the passive energy present in each of their respective IF sidebands centred around their corresponding predominant even order mixing frequency.

Referring also to FIG. 7, if an electrical bias 700 (or an increased electrical bias 700) is now applied to the diode pairs in the second mixer array, these being indicated as producing IF signals 5 to 8 in FIG. 8, each mixer 120 in that array is no longer balanced, having the shifted current/voltage characteristic seen in FIG. 7b. Each mixer 120 in the second array will now have the frequency response shown in FIG. 5. Each mixer 120 in the second array will thus produce power at both even and odd order harmonics of the LO source 2 frequency, at 251 GHz, 376.5 GHz etc, and will also mix at both the even and the odd order harmonics. Now each mixer 120 in the second array will therefore be producing a relatively strong signal at 251 GHz which each mixer in the first array can detect by mixing at its second harmonic which is 250 GHz. Thus the mixers of the second array can illuminate the field of view for the mixers of the first array.

The bias current 700 for producing the transmitter mode of the mixer 120 would typically be between 0 mA and Idmax (the maximum diode current as specified by the device manufacturer). This bias current would be fed into the mixer IF port using a ‘Bias Tee’ (shown with reference numeral 1700 in FIG. 17). This is a known arrangement consisting of an inductor and capacitor to allow the flow of DC current into the IF pin while creating a high impedance load. The high impedance load prevents loss of IF signal due to the bias tee. For a GaAs diode in the frequency of operation described above this would typically be around 1 mA.

Consequently it is clear that by biasing the anti-parallel diode pairs in mixers 120 of an imaging array, a passive imager can be electronically switched to become an active imager. The controlled electrical bias 700 provides a mode control.

Taking this embodiment one step further, if a small electrical bias 700 is also applied to diodes of mixers 120 in the first array, then this will cause harmonics to be generated at both even and odd order harmonics of the LO source 1 frequency, at 250 GHz, 375 GHz etc. Now the first array becomes active as well as the second array. Signals generated in the first array will now illuminate the field of view for detection by the mixers of the second array. The signal generated in the first array at the second harmonic can be down converted to appear as a strong IF output at 1 GHz, again twice the difference between the two LO sources.

Since all the mixers 120 are now mixing at all harmonics, there may also be a contribution to the IF output at 1.5 GHz from the third harmonic but the power drops off very significantly towards any higher harmonics.

In the case that there is no electrical bias 700 which can be controlled to switch as described above, and for instance intrinsic imbalances in diode pairs are relied on instead to create an active array, it is of course an alternative simply to switch off transmitting mixers in the array. This will equally switch the array into passive mode but with only a reduced number of receivers operating.

### Switched Passive/Active Array: Fixed Imbalance, Switched by LO Frequency

Alternatively, a second way in which a passive imager can be switched into an active array is to tune electronically, in frequency, one or more of the LO sources 125 to be either equal or different to that of the other source and use the residual even order harmonic signal generated by the imperfections within the diode pair. When the LO sources 125 have the same frequency the array is passive but when the LO sources 125 have slightly different frequencies, the imperfections in the diode pair provide an imbalance sufficient to generate even harmonics and thus an active array. A frequency control 145 (shown in FIG. 1) can be provided in known manner by changing the tuning voltage on the LO source 125, for instance using a phase locked loop (“PLL”) circuit. Whilst a perfectly balanced anti-symmetrical diode pair will not generate even order harmonics of the LO frequency, in practice this is difficult to realise and there will be some imbalance. This will result in some power being generated at the even order harmonics. This is generally one or two orders of magnitude lower than that generated by an asymmetric diode characteristic. However, with the extreme sensitivities available with the heterodyne technique then it may still represent a significant signal strength over and above that required for effective imaging.

In the above, switching (mode control) is provided by using the frequency control 145 to retune at least one LO 125. Referring to FIG. 16, in an alternative arrangement for mode control between active and passive behaviours, it is possible to use two LOs of different frequencies, LO Source 1 and LO Source 2 as shown, say having frequencies of 125 GHz and 125.5 GHz. LO Source 2 has twice the power of LO Source 1. There is a switch arrangement 1600 in the input chain which can be switched between two conditions, a passive mode condition (shown in solid lines) in which all the mixers 120 are driven from LO Source 2 while LO Source 1 is directed to a matched termination 1605, and an active mode condition (shown in dotted lines) in which half the mixers 120 are driven from LO Source 1 and half from LO Source 2. In the active mode condition, half the power of LO Source 2 goes to the matched termination 1605. This provides a method for effectively switching the frequency of half the LOs supplying the mixers 120 between two different frequencies, the switch arrangement 1600 now providing a frequency control.

It might be noted that in this form of switching, some of the mixers 120 may still emit radiation towards the field of view but it can no longer be detected except perhaps at a low level. Thus any IF output of any of the mixers 120 is based predominantly or entirely on ambient radiation or radiation from another source rather than on radiation transmitted from mixers in the switched array.

### Switched Passive/Active Array: Modulated LO

If an oscillator is modulated in any way then there will exist the carrier as well as a number of sidebands depending on the type of modulation and the modulating signal. Referring to FIG. 8, a modulator 800 can be provided to one or both LOs 125.

For example if an oscillator of 125 GHz were amplitude modulated by a sine wave of 1 GHz (shown as a line 1200 in FIG. 12) then, referring to FIG. 13, there will be three tones 1300, 1305, 1310 that could be observed on a spectrum analyser, these being the carrier of 125 GHz and a pair of tones each 1 GHz above and below the carrier (124 and 126 GHz). The amplitude of these sidebands 1300, 1310 in this case would be dependant on the amplitude of the 1 GHz modulation sinewave and the modulation depth (“Beta”) and the carrier would be the amplitude of the carrier signal without modulation.

If on the other hand an oscillator of 125 GHz were to be phase or frequency modulated by a 1 GHz sinewave, there would be an infinite number of sidebands generated at 1 GHz increments in frequency from the carrier, 126, 127, 128 . . . etc GHz and 124, 123, 122 . . . Ghz. The carrier (125 GHz) would not then be of the same amplitude as the unmodulated oscillator as the total power must be constant. The amplitude of the sidebands and carrier will be dependant on the amplitude of the modulating signal as well as Beta. This is all very much known and understood and is documented in much literature concerning communications theory.

As explained above, if a system has more than one LO which is individually controllable in terms of frequency, modulation or a combination of both, then it can be seen that any modulated sideband or difference in frequencies between the oscillators will be downconverted as described above. For example in the amplitude modulation case described above with a 1 GHz sinewave modulated signal, then the two sidebands 1300, 1310 would be downconverted to + and −1 GHz. In the case of the phase or frequency modulated case, then there would be an infinite amount of downconverted at +/−1 GHz spacing (1 GHz, 2 GHz, 3 GHz . . . ).

The use of one or more modulated LOs offers a further means of switching between active and passive behaviour in an array of transmitter/receivers since a modulator 800 can be switched on and off using a modulation control 805.

### Active Array: Modulated by Field of View

Referring to FIG. 15, in practice, a first array of feedhorns 115a (only one shown) might be used to illuminate an object 1515 in a field of view 1505 and a second array of feedhorns 115b (only one shown) might be used to capture radiation 1530 coming back from the field of view 1505. A scanning device 1500 such as a mirror scans the radiation over the field of view and, in known arrangements, optic devices 1530 are used to capture reflected THz radiation 1530 and deliver it the receiving feedhorns 115b. These same optic devices 1530 will operate reciprocally to deliver the signals generated 1525 in the transmitting mixer array 115a to the field of view 1505.

Although the optic devices may collimate the radiation 1525 being delivered to the field of view 1505, the nature of the aperture of the feedhorns 115 means that each feedhorn 115 will capture incoming radiation 1530 over a somewhat wider angle. Consequently, that part of a field of view 1505 being imaged by a receiving array of mixers 115b can be effectively illuminated directly by the radiation emanating from the transmitting mixer array 115a. This can be mixed in the receiving array 115b to create sidebands at a multiple of a difference frequency between the two LO sources 125, that is at 1 GHz at the second harmonic and 1.5 GHz at the third harmonic, which can then be down converted to appear at the IF outputs (shown as IF1 to IF4 in FIG. 8) of the mixers in the receiving array.

Since the radiation patterns of each horn are not completely orthogonal the signal radiating from the transmitting array will inevitably be received by the receiving array. Due to the surface contours of the subject varying levels of reflected signal will be returned providing contrast information for use in constructing a resulting image. Modulation of the received signal will be caused by varying reflectivity, that is effective amplitude, in the image plane caused by the material properties and angled specular reflection of surfaces which are not normal to the direction of propagation.

This imaging option arises because, even with the best will in the world, all circuits have an offset that is not 0V. Even where two mixers are operating on the same frequency, these will produce an additional DC signal to the ‘natural’ DC offset produced in the mixer. The process of placing an object in the field of view will by its very nature change this DC signal. Movement of the object or scanning of the field of view will tend to affect the DC signal. Whilst it may not be easy to obtain image information from the DC signal due to noise, arising for instance due to thermal effects in the mixer and other drift phenomena, it still would be theoretically possible to obtain picture information out of this DC signal.

### Detection of Moving Target

With the correct form of modulation and or LO frequencies it would be possible for example to determine if a target was moving towards or away from the detector. The returned signal would be either lowered or raised in frequency due to the Doppler shift effect as a target moved away or towards the receiver. It should also be noted that if the local oscillators are of the same frequency then a DC signal will be created which may have spectral components either side of it (positive and negative in frequency) which will vary with the Doppler frequency shift.

The spectral components arise because the relative Doppler shift between different pixels will be different due to objects not necessarily moving at the same rate for a target moving towards or away from the camera (that is, the receiving array). That is, in the case of a person, there can be for example differential movement because of a time lag for a heavy object, perhaps carried in a pocket, compared with the rest of their clothing. This will be caused by its natural moment of inertia. In this way, it may in practice be possible to determine the effective mass of an object held in relation to a moving person.

### Summary: Active Arrays

Thus there is more than one way of achieving an intermediate frequency for use in detection in embodiments of the present invention. These can be summarised as follows:
the LOs of the transmitting and receiving mixers have different frequencies
the LOs may optionally have the same frequency but one or both of the LOs is modulated
the LOs have the same nominal frequency but scanning or viewing a target produces a variation in a DC component such that a detectable IF component will be produced.
   Low IF bandwidth

An advantage of embodiments of the invention is that only a low bandwidth IF output is necessary. This simplifies amplification.

As these sources are under control of the system then it should be obvious and determinable where these product signals will lie in the IF chain. Since it is possible to switch in filters in the IF chain that are tailored to around the expected return signal from a target or field of view, then the bandwidth of the IF chain can be constrained from the many GHz of the passive case as described above to a fraction of this bandwidth. Since noise power is the integration of noise power density in a defined bandwidth then if the bandwidth is constrained to a fraction of that of the passive system, and if the power of the signal from the target or field of view is either kept constant or in fact increased as would be the case with the active system, then the SNR would be increased by the same factor as the bandwidth is reduced, and also the increased returned power.

If for example the two oscillators are as described above where one is at 125 GHz and the other is at 125.5 GHz (appearing as lines 405, 1000 at 250 GHz and 251 GHz in the mixer, as shown in FIG. 10), then the resulting signal returned from the target would be a 1 GHz tone (shown as a line 1100 in FIG. 11), the two LOs being doubled in frequency. The bandwidth 1105 of the IF chain would only have to be wide enough to take into account the frequency uncertainty and any Doppler frequency shift that would need to be included to receive the returned signal properly. This bandwidth 1105 could be as low as a few KHz or lower. If for example this were 10 KHz, compared with the situation with an equivalent passive system where the IF bandwidth would be 10 GHz, then the increase in signal to noise ratio (“SNR”) purely due to the constraining of the IF bandwidth would be a factor of 1,000,000 or 60 dB. It may be possible to have bandwidths much less than the 10 KHz presented here, maybe even as low as a couple of Hz bandwidth in which case 90 to 100 dB increase in SNR could be obtained purely from the reduction in bandwidth.

### Switched High/Low Bandwidth Outputs

Referring to FIG. 14, the modulating signal need not be of such a high frequency if the two sources (LOs) 125 of a transmitting and a receiving mixer are locked together in frequency terms: the downconverted signal will consist of tones very close to direct current (“DC”) in the baseband. These signals would be very easy to put through low noise narrow bandwidth baseband amplifiers 105. These amplifiers 105 could be very cheap op-amp type amplifiers rather than expensive low noise wide bandwidth RF amplifiers 1420 in an equivalent passive system. It is possible then to use a low pass filter 1405 after the amplifier 105. This low pass filter could be an analogue filter 1405, a digital filter 135 following an analogue to digital converter 130 (“ADC”) as shown in FIG. 1, or an ADC whose sample rate has been judiciously chosen so that the combination of downconverted tones all fell on to the same frequency due to the inherent mixing process in the conversion from analogue to digital and vice versa. For example if the modulated signal was a 0.5 GHz sinewave frequency modulation (“FM”) which would produce an infinite amount of sidebands at 1 GHz spacing (1 GHz as opposed to 0.5 GHz due to the frequency doubling in the mixer), and an ADC were to sample the amplified IF signal with a sample rate of 1500 MHz, then all the tones will be aliased into the digital domain at 500 MHz. A filter could be constructed to pass only these signals and remove all the other bandwidth components.

In a further alternative arrangement using an ADC, the IF signal can be mixed with another oscillator with the same frequencies as the ADC sample frequency example above (1500 MHz). The second oscillator could be at 1.5 GHz and due to the non linear properties of mixers the multiples of the LO signal would mix the tones all to 500 MHz. (An ADC has similar properties to a mixer. The mixer will mix +/−m +/−n where m and n are the two input frequency components and an ADC will alias +/−m +/−n frequency components to the same output frequency.) Again the bandwidth around this wanted signal could be very small: of the order of Hz if necessary.

A further alternative would be to mix (either by way of mixer or ADC) the resultant signal above (500 MHz) to a yet much lower frequency for processing in the filters that are available at these frequencies. This last is an approach used in double or triple heterodyne techniques.

### Multi-Frequency Detection

With something like frequency modulation (“FM”) of the LO 125 with a sine wave or a more complex waveform, at the correct modulating frequency and the correct modulation index then a number of returned signals would fall into the IF band. If for example these sidebands were separated by 10 GHz (a 5 GHz modulation sine wave signal—doubled in frequency by the mixer—in say an FM modulated carrier) then detection of a target at many different frequencies could be obtained either simultaneously or in a very short period of time especially if the modulation were changed dynamically. For example, the modulation index could be altered or the modulation source frequency could be swept or ramped from a low frequency to a large frequency.

Another example of multi-frequency detection would be to frequency modulate one of the LOs with a sinewave of say 5 GHz. In the example above where the LOs are doubled in frequency in the mixers then the sidebands would be 10 GHz apart. If the correct modulation index were used, then the signal could for example have sidebands at 100 GHz or more away from the LO. For example, if the modulation index of FM were moved up from 0 to a high number, then strong signals at different RF frequencies would be present. Analysis of the IF signals could detect hidden material that only reflected radiation at certain frequencies. If the complex (I and Q) component of the IF signal were separated out then it would even be possible to determine which of the returned sidebands (positive or negative) were responsible for the returned IF signal. (Separation of the complex components can be done in known manner using an off-the-shelf component such as a “Complex mixer”.)

### Simultaneous Active/Passive Modes

Referring to FIG. 17, an additional mode of operation is to have both active and passive modes in operation at the same time. This can be achieved by using a low frequency offset between the two local oscillators 125 and an electronic splitting device 1700, such as the “bias tee” mentioned above with reference to FIG. 7, to deliver very low frequency signals via a low frequency amplifier 105 to the active detection system 1410 and high frequency signals via a high frequency amplifier 1420 to the passive detection system 1415. For example, the offset between the LOs might be of the order of 5 MHz, the very low frequency signals might be up to 20 MHz and the high frequency signals might be 100 MHz and above.

The bias tee 1700 can also be used to deliver the bias current 700 to diodes of the mixer 120. Suitable bias tees are commercially available and characterised by their insertion losses and cut-off frequencies.

This arrangement allows the low frequency ‘active’ system to produce a signal that is only seen by low frequency electronics and will not influence the high frequency electronics where it would dominate. The high frequency “passive” signal will not dominate so it can either be allowed into the low frequency electronics or excluded as design criteria dictate.

Thus the bias tee 1700 provides a signal splitter for splitting a detection signal to follow at least two separate detection paths. The signal can be split according to frequency characteristics such as frequencies below a first threshold frequency (active signal) and frequencies above a second threshold frequency (passive signal).

This active/passive mode would allow dual mode viewing of a subject simultaneously, allowing cross correlation information to be gleaned and presented to the user as well as independent information.

### Tracking

Metallic objects will always reflect the terahertz power in the surrounding environment. With a relatively uniform environmental temperature, there will always be ambient temperature terahertz radiation directed into the imaging system. With an on-axis active detection system according to an embodiment of the present invention, where transmitters and receivers sit in the same array and effectively create a beam of terahertz radiation instead of a more uniform flood illumination, the situation is quite different. In order to see the target it is then necessary to bounce the beam off the target in such a way that the beam substantially retraces its path. Such reflection is well known in the field of optics and is typified by cat's eyes (the animal), “cat's eyes” (on roads) and bicycle reflectors. Such items as corner cube reflectors would then make deliberate tracking of distant objects very easy.

### Glint Detection

In a surveillance situation, objects are deliberately concealed and the true shape of such objects would not be visible using an on-axis illumination scheme. However it would not be possible to completely hide metallic objects as edges would produce massive return signals compared to the ambient terahertz radiation. Covering or coating the metallic objects would be relatively ineffective since such coatings and coverings would have to absorb most of the incoming terahertz energy to be effective at concealing the metallic objects; such absorbing materials are not readily available for mm wave and terahertz frequencies. Note that even the reflection from non-metallic objects can be very strong when the angle of the object is such as to return the beam directly on axis.

With on-axis illumination, that is, using a beam as produced by an embodiment of the present invention, the system becomes similar to a RADAR system and objects can be considered in relation to their Terahertz reflection cross-sections. Rather than seeing the object shape, the existence of the object becomes apparent from the glint (sparkle) and further investigations can then be made. In fact the movement of the target with a person assists in the determination of the threat, since there is more likelihood of getting glint off different parts of the concealed object(s).

An important aspect of getting such a scheme working well might be a requirement to filter the incoming signal by either analogue or digital means to limit the extent of the glint. Suppose, for example, that the glint off the target is 1000× stronger than the typical range seen when viewing a person. If the display colours were scaled to this strong signal then the rest of the image would be “washed out” (lacking contrast) as a result. Referring to FIG. 14, typical glint filtering could be provided by a signal limiter 1425 which provides analogue clipping in the detector circuit, logarithmic compression of the digital data, digitally limiting the signal range on fast transients using the difference between adjacent sample points to identify the transients (a non-linear derivative filter) and so forth.

1. An electromagnetic radiation detection system, the system comprising a transmitter for transmitting radiation towards a target and a receiver for receiving radiation from the target, the received radiation having been transmitted by the transmitter, wherein the transmitter and receiver each have: i) an input for a signal provided by a local source; and ii) a mixer for generating a signal by use of the signal provided by the local source and comprising at least one frequency different from that of the local source, and wherein, in use, the received radiation is mixed by the receiver with a signal based on that provided by its local source to give a detection signal in relation to the target, the detection signal having an intermediate frequency characteristic.

2. A system according to claim 1 wherein the transmitter and the receiver share the same local source.

3. A system according to claim 1 wherein the local sources of the transmitter and of the receiver have a frequency difference with respect to each other, at least one harmonic of which can be mixed in the mixer of the receiver to give an intermediate frequency.

4. A system according to claim 3 wherein a frequency control is provided to change the frequency difference.

5. A system according to claim 1 wherein the transmitter and the receiver are adapted to be reciprocal, in use, each acting as a receiver for radiation transmitted by the other.

6. A system according to claim 1, further comprising at least one modulator for modulating the signal of at least one local source.

7. A system according to claim 6 wherein a modulator of said at least one modulator (s) provides amplitude modulation.

8. A system according to claim 6 wherein a modulator of said at least one modulator (s) provides frequency or phase modulation.

9. A system according to claim 6 wherein a modulation control is provided for controlling the level of modulation.

10. A system according to claim 6 wherein the local source of the transmitter and the local source of the receiver are locked to the same or substantially the same frequency.

11. A system according to claim 1 wherein the wavelength characteristic of the transmitted radiation lies in the centimetre to sub-millimetre range.

12. A system according to claim 11 wherein the transmitted radiation comprises terahertz radiation.

13. A system according to claim 1 wherein the mixer of the transmitter comprises an anti-parallel pair of diodes.

14. A system according to claim 13 wherein the pair of diodes is intrinsically unbalanced.

15. A system according to claim 13 wherein the pair of diodes is provided with an electrical bias for varying the degree of balance between the diodes.

16. A system according to claim 1 wherein the receiver is provided with a signal splitter for splitting a detection signal to follow at least two separate detection paths.

17. A system according to claim 16 wherein the signal splitter is adapted to split the detection signal into two detection signals having different frequency characteristics.

18. A system according to claim 17 wherein the different frequency characteristics comprise frequencies below a first threshold frequency and frequencies above a second threshold frequency.

19. A system according to claim 1, further provided with a mode control for controlling at least one characteristic of the transmitter and/or receiver such that the system can be switched, in use, between an active mode, in which the transmitter transmits said radiation towards the target for reception by the receiver to give said detection signal, and a passive mode in which the receiver at least substantially ceases to receive and mix the transmitted radiation to give said detection signal.

20. A system according to claim 19 wherein the mode control comprises a switch for switching power on and off to the transmitter.

21. A system according to claim 19 wherein the mixer of the transmitter comprises an anti-parallel pair of diodes and the diodes are provided with an electrical bias for varying the degree of balance between the diodes, the mode control being adapted to change the degree of electrical bias.

22. A system according to claim 19 wherein the mixer of the receiver comprises an anti-parallel pair of diodes and the diodes are provided with an electrical bias for varying the degree of balance between the diodes, the mode control being adapted to change the degree of electrical bias.

23. A system according to claim 1 wherein each mixer comprises a sub-harmonic mixer.

24. A system according to claim 1, further comprising a detection signal limiter for limiting the maximum response of the system to received radiation.

25. A transmitter/receiver for use in a system claim 1, the transmitter/receiver comprising:
i) an input for a signal provided by a local source;
ii) a mixer comprising a pair of anti-parallel diodes for generating a signal based at least in part on the signal provided by the local source;
iii) an electrical bias input for providing an electrical bias to at least one of the diodes so as to control the balance between the diodes; and
iv) an electrical bias control for controlling the level of the electrical bias so as to control said balance and thus the frequency content of the generated signal.

26. A transmitter/receiver according to claim 25, further comprising a modulator for modulating the signal provided by the local source.

27. A transmitter/receiver according to claim 25 wherein the wavelength characteristic of the generated signal lies in the centimetre to sub-millimetre range.

28. A transmitter/receiver according to claim 27 wherein the generated signal comprises terahertz radiation.

29. An electromagnetic radiation detection system comprising an array of at least two transmitter/receivers according to claim 25, each electrical bias control being arranged to switch the diodes of a transmitter/receiver between balanced and unbalanced states.

30. A scanning electromagnetic radiation detection system comprising:
i) at least one transmitter for transmitting radiation towards a target;
ii) at least one receiver for receiving radiation from the target, said radiation having been transmitted by the transmitter; and
iii) a scanner for scanning the target, wherein the scanner is arranged to scan the at least one transmitter and the at least one receiver synchronously with respect to the target.

31. An electromagnetic radiation detection system comprising an array of:
i) at least one transmitter for transmitting radiation towards a target; and
ii) at least one receiver for receiving radiation from the target, said radiation having been transmitted by the transmitter; wherein said transmitted radiation has more than one discrete frequency.

32. A system according to claim 31, comprising more than one transmitter, wherein different discrete frequencies are transmitted by different respective transmitters.

33. A system according to claim 29 wherein the wavelength characteristic of the transmitted radiation lies in the centimetre to sub-millimetre range.

34. A system according to claim 33 wherein the transmitted radiation comprises terahertz radiation.
